(19) United States
(12) Patent Application Publication
(10) Pub. No.: US 2026/0223240 A1
(43) Pub. Date: Jul. 30, 2026

(54) DISCONTINUOUS RECEPTION AND LOW-POWER WAKEUP SIGNALS FOR WIRELESS COMMUNICATION

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Igor GUTMAN, Hod HaSharon (IL); Tao LUO, San Diego, CA (US)

(21) Appl. No.: 19/036,851

(22) Filed: Jan. 24, 2025

(51) Int. Cl. H04W 76/28; H04W 52/02; H04W 72/232

(52) U.S. Cl. CPC H04W 76/28; H04W 52/0235; H04W 72/232

(57) ABSTRACT

Methods, systems, and devices for wireless communications are described. A user equipment (UE) may support low-power wake-up signal (LP-WUS) monitoring within a discontinuous reception (DRX) cycle active time in accordance with an LP-WUS monitoring configuration to trigger downlink monitoring. The UE may receive one or more indications of a DRX configuration. The DRX configuration may include an on duration of a DRX cycle and a set of one or more LP-WUS monitoring occasions associated with the DRX cycle. The UE may monitor for LP-WUSs associated with the UE during each of the set of one or more LP-WUS monitoring occasions. Then, the UE may monitor for downlink transmissions in the on duration of the DRX cycle based on whether an LP-WUS was received by the UE in accordance with the monitoring for LP-WUSs.

### TECHNICAL FIELD

The following relates to wireless communications, including discontinuous reception and low-power wakeup signals for wireless communication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information indicating an on duration of a discontinuous reception (DRX) cycle and a set of one or more low-power wake-up signal (LP-WUS) monitoring occasions associated with the DRX cycle, monitoring, in accordance with the set of one or more LP-WUS monitoring occasions associated with the DRX cycle, for LP-WUSs associated with the UE, and monitoring, in the on duration of the DRX cycle, for physical downlink control channel (PDCCH) transmissions associated with the UE based on whether a LP-WUS associated with the UE was received by the UE in accordance with the monitoring for LP-WUSs associated with the UE.

A UE for wireless communications is described. The UE may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive configuration information indicating an on duration of a DRX cycle and a set of one or more LP-WUS monitoring occasions associated with the DRX cycle, monitor, in accordance with the set of one or more LP-WUS monitoring occasions associated with the DRX cycle, for LP-WUSs associated with the UE, and monitor, in the on duration of the DRX cycle, for PDCCH transmissions associated with the UE based on whether a LP-WUS associated with the UE was received by the UE in accordance with the monitoring for LP-WUSs associated with the UE.

Another UE for wireless communications is described. The UE may include means for receiving configuration information indicating an on duration of a DRX cycle and a set of one or more LP-WUS monitoring occasions associated with the DRX cycle, means for monitoring, in accordance with the set of one or more LP-WUS monitoring occasions associated with the DRX cycle, for LP-WUSs associated with the UE, and means for monitoring, in the on duration of the DRX cycle, for PDCCH transmissions associated with the UE based on whether a LP-WUS associated with the UE was received by the UE in accordance with the monitoring for LP-WUSs associated with the UE.

A non-transitory computer-readable medium storing code for wireless communications is described. The code may include instructions executable by one or more processors (e.g., directly, indirectly, after pre-processing, without pre-processing) to receive configuration information indicating an on duration of a DRX cycle and a set of one or more LP-WUS monitoring occasions associated with the DRX cycle, monitor, in accordance with the set of one or more LP-WUS monitoring occasions associated with the DRX cycle, for LP-WUSs associated with the UE, and monitor, in the on duration of the DRX cycle, for PDCCH transmissions associated with the UE based on whether a LP-WUS associated with the UE was received by the UE in accordance with the monitoring for LP-WUSs associated with the UE.

In some examples of the method, UEs, and non-transitory computer-readable medium described herein, monitoring for the PDCCH transmissions may include operations, features, means, or instructions for monitoring for the PDCCH transmissions for a first duration in response to a reception of the LP-WUS.

Some examples of the method, UEs, and non-transitory computer-readable medium described herein may further include operations, features, means, or instructions for receiving, in the first duration, a PDCCH transmission based on monitoring for the PDCCH transmissions, starting an inactivity timer in response to receiving the PDCCH transmission, and continuing to monitor for the PDCCH transmissions based on a state of the inactivity timer, where the first duration may be based on the state of the inactivity timer.

In some examples of the method, UEs, and non-transitory computer-readable medium described herein, continuing to monitor for the PDCCH transmissions may include operations, features, means, or instructions for continuing to monitor for the PDCCH transmissions until an expiration of the inactivity timer.

In some examples of the method, UEs, and non-transitory computer-readable medium described herein, continuing to monitor for the PDCCH transmissions may include operations, features, means, or instructions for continuing to monitor for the PDCCH transmissions until an end of a PDCCH monitoring window corresponding to the LP-WUS.

Some examples of the method, UEs, and non-transitory computer-readable medium described herein may further include operations, features, means, or instructions for refraining from monitoring for the PDCCH transmissions based on not receiving the LP-WUS.

In some examples of the method, UEs, and non-transitory computer-readable medium described herein, at least one of the set of one or more LP-WUS monitoring occasions may be configured to occur before the on duration of the DRX cycle.

In some examples of the method, UEs, and non-transitory computer-readable medium described herein, at least one of the set of one or more LP-WUS monitoring occasions may be configured to occur in the on duration of the DRX cycle.

In some examples of the method, UEs, and non-transitory computer-readable medium described herein, at least one of the set of one or more LP-WUS monitoring occasions may be configured to occur while a timer associated with the on duration of the DRX cycle may be running.

In some examples of the method, UEs, and non-transitory computer-readable medium described herein, the monitoring for LP-WUSs associated with the UE corresponds to a continuous monitoring in the on duration of the DRX cycle.

Some examples of the method, UEs, and non-transitory computer-readable medium described herein may further include operations, features, means, or instructions for operating, while monitoring for LP-WUSs associated with the UE, a reception system of the UE in accordance with a first power mode associated with a first wakeup duration and a first operating power and operating, in an off duration of the DRX cycle, the reception system in accordance with a second power mode associated with a second wakeup duration that may be greater than the first wakeup duration and a second operating power that may be less than the first operating power.

Some examples of the method, UEs, and non-transitory computer-readable medium described herein may further include operations, features, means, or instructions for receiving the LP-WUS associated with the UE in accordance with the monitoring for LP-WUSs associated with the UE and operating, in response to receiving the LP-WUS, the reception system in accordance with a third power mode corresponding to an awake state of the reception system, different than the first power mode and the second power mode, where monitoring for the PDCCH transmissions may be based on operating the reception system in accordance with the third power mode.

In some examples of the method, UEs, and non-transitory computer-readable medium described herein, the configuration information indicates that a periodicity of the DRX cycle corresponds to a video frame rate of an application.

In some examples of the method, UEs, and non-transitory computer-readable medium described herein, the set of one or more LP-WUS monitoring occasions may be associated with a set of multiple occasions in accordance with a periodic interval.

In some examples of the method, UEs, and non-transitory computer-readable medium described herein, respective durations between consecutive LP-WUS monitoring occasions of the set may be equal.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports discontinuous reception (DRX) and low-power wakeup signals (LP-WUSs) for wireless communication in accordance with one or more aspects of the present disclosure.

FIG. 2 shows an example of a wireless communications system that supports DRX and LP-WUSs for wireless communication in accordance with one or more aspects of the present disclosure.

FIG. 3 shows an example of a process flow that supports DRX and LP-WUSs for wireless communication in accordance with one or more aspects of the present disclosure.

FIGS. 4 and 5 show block diagrams of devices that support DRX and LP-WUSs for wireless communication in accordance with one or more aspects of the present disclosure.

FIG. 6 shows a block diagram of a communications manager that supports DRX and LP-WUSs for wireless communication in accordance with one or more aspects of the present disclosure.

FIG. 7 shows a diagram of a system including a device that supports DRX and LP-WUSs for wireless communication in accordance with one or more aspects of the present disclosure.

FIGS. 8 through 10 show flowcharts illustrating methods that support DRX and LP-WUSs for wireless communication in accordance with one or more aspects of the present disclosure.

### DETAILED DESCRIPTION

In some wireless communications systems, a user equipment (UE) may operate in accordance with discontinuous reception (DRX) cycles (e.g., connected-mode DRX (C-DRX) cycles). During an off duration of a DRX cycle, the UE may enter a sleep mode, which may include refraining for monitoring for transmissions to conserve power at the UE. During an on duration of the DRX cycle, the UE may monitor for one or more transmissions using a relatively high-power radio. In an effort to ensure no transmissions are missed, the UE may use the relatively high-power radio for monitoring even in cases where no transmissions are to be received during the on duration. Using such a high-power radio may result in inefficient power usage at the UE, which may reduce battery life and diminishing the user experience.

Techniques described herein may support low-power wake-up signal (LP-WUS) monitoring within a DRX cycle active time, in accordance with an LP-WUS monitoring configuration, to trigger physical downlink control channel (PDCCH) monitoring. For example, a UE may receive one or more indications of a DRX configuration. The DRX configuration may include an on duration of a DRX cycle and a set of one or more LP-WUS monitoring occasions (MOs) associated with the DRX cycle. The UE may monitor for LP-WUSs associated with the UE in accordance with the set of one or more LP-WUS MOs associated with the DRX cycle. In some examples, the UE may monitor for downlink transmissions (e.g., PDCCH transmissions) associated with the UE in the on duration of the DRX cycle. For example, the UE may monitor for the downlink transmissions based on whether an LP-WUS associated with the UE was received by the UE in accordance with the monitoring for LP-WUSs associated with the UE. For example, if the UE receives an LP-WUS, the UE may begin monitoring for the downlink transmissions for a monitoring duration associated with the received LP-WUS.

Aspects of the disclosure are initially described in the context of wireless communications systems. Aspects of the disclosure are further illustrated by and described with reference to apparatus diagrams, system diagrams, and flowcharts that relate to DRX and LP-WUSs for wireless communication.

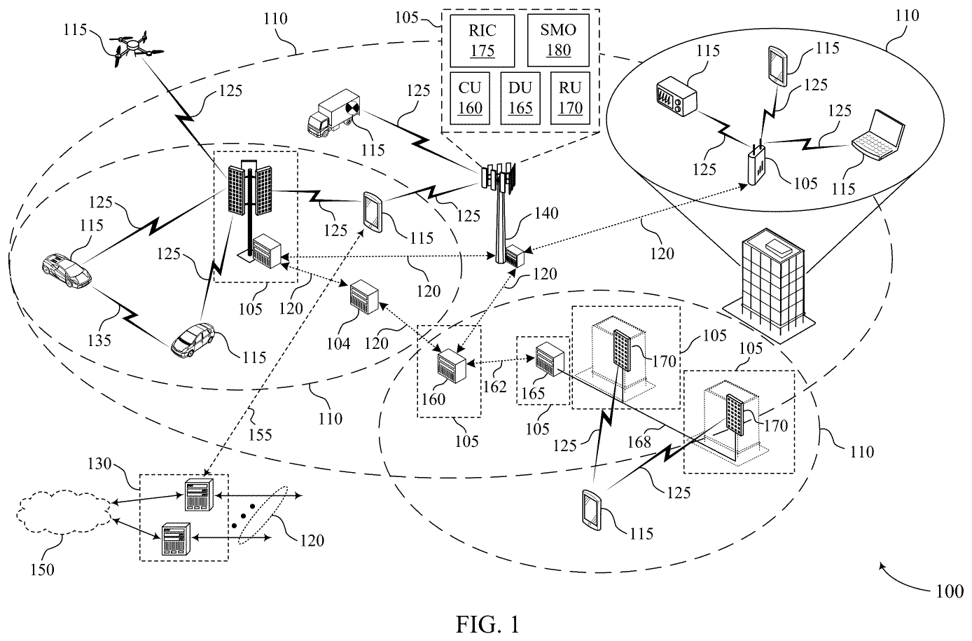

FIG. 1 shows an example of a wireless communications system 100 that supports DRX and LP-WUSs for wireless communication in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support DRX and LP-WUSs for wireless communication as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may support LP-WUS triggered PDCCH monitoring with a DRX configuration (e.g., a connected-mode DRX (C-DRX) configuration), which may support a power saving procedure for an RRC connected mode. For LP-WUS triggered PDCCH monitoring, a UE 115 may be equipped with a low-power wake-up receiver or radio (LP-WUR) in addition to a main receiver (e.g., a main receiver or radio (MR)). The UE 115 may be configured to switch the LP-WUR on and off relatively quickly, and may be configured to receive and process simple signals via the LP-WUR (e.g., the UE 115 may use a reduced bandwidth, a simpler waveform, or both for receiving signals via the LP-WUR). However, the LP-WUR may not be configured to communicate more complex signals. An LP-WUS may be an on-off keying (OOK) waveform. Accordingly, the UE 115 may use less power to operate the LP-WUR than to operate the MR.

The UE 115 may perform LP-WUS triggered PDCCH monitoring in accordance with a set of procedures. For example, the UE 115 may switch off the MR to save power (e.g., entering a deep sleep mode). In some cases while the MR is switched off, the UE 115 may use the LP-WUR to monitor for LP-WUSs. If the UE 115 receives an LP-WUS from a network entity 105, the UE 115 may wake up (e.g., switch on) the MR and may begin monitoring for one or more control messages from the network using the MR.

In some wireless communications systems, a UE may perform one or more power saving procedures (e.g., C-DRX). To perform C-DRX, the UE may periodically wake up to monitor for control messages from a network entity via PDCCH. The UE may operate during an inactive time (e.g., outside an active time, or outside a window for monitoring PDCCH). During the inactive time, the UE may be configured or permitted (e.g., allowed) to enter a sleep mode. In some cases, a periodicity of the PDCCH monitoring may be fixed (e.g., after the periodicity is configured). In such cases, the UE may wake up and monitor the PDCCH in each on duration in accordance with the periodicity (e.g., even in cases where the network entity has not transmitted a control message to the UE). As a result, periodic PDCCH monitoring may limit power savings, gains, and performance (e.g., increased latency).

In some wireless communications systems, a UE may follow one or more LP-WUS procedures to trigger PDCCH monitoring in RRC connected mode. For example, PDCCH monitoring may be triggered by an LP-WUS with a C-DRX configuration. In some cases, the UE may perform LP-WUS monitoring in accordance with an LP-WUS monitoring configuration before a start of an on duration timer (e.g., drx-onDurationTimer) to trigger the start of the on duration timer. In some examples, the UE may perform LP-WUS monitoring outside a C-DRX active time in accordance with an LP-WUS monitoring configuration to trigger PDCCH monitoring. In some cases, the UE may perform PDCCH monitoring irrespective of the on duration timer (e.g., drx-onDurationTimer). In some implementations, PDCCH monitoring may be based on C-DRX cycles. For example, PDCCH monitoring may be triggered based on a C-DRX cycle and based on the on duration timer while monitoring for LP-WUS. To save power in such an example, the UE may also monitor for PDCCH transmissions in accordance with an LP-WUS monitoring configuration before a start of the on duration timer. In some other examples, PDCCH monitoring may not be triggered by the C-DRX cycle and the on duration timer while monitoring for LP-WUS. In some implementations, the UE may perform LP-WUS monitoring during a C-DRX active time in accordance with the LP-WUS monitoring configuration to trigger PDCCH monitoring.

In some wireless communications systems, a UE may be configured for receiving downlink control information of power saving (DCP) signals. A DCP signal may be a wake up signal (e.g., similar to LP-WUS) transmitted in downlink control information (DCI). A UE may receive the DCP signal using the MR (e.g., and not the LP-WUR). The UE may search (e.g., monitor) for DCP signals starting at an offset (e.g., ps-Offset-r16) before a start of an on duration timer (e.g., drx-OnDurationTimer). The offset may correspond with a start of a search-time of a DCI format (e.g., DCI format 2-6) with a cyclic redundancy check (CRC) scrambled by a power-saving radio network temporary identifier (PS-RNTI) relative to the start of the on duration timer (e.g., corresponding to Long DRX). A value of the offset may be represented in multiples of 0.125 ms (milliseconds) (e.g., 1 may correspond to 0.125 ms, 2 may correspond to 0.25 ms, 3 may correspond to 0.375 ms, and so on).

A DRX cycle may start at a beginning of a subframe (e.g., before the start of the on duration timer). In some cases, the UE may monitor a PDCCH on a serving cell during an active time of the DRX cycle. The active time may include a time during which the on duration timer or an inactivity timer configured for the DRX group (e.g., drx-InactivityTimer) is running (or a time during which both timers are running). If the UE receives a PDCCH transmission that indicates a new transmission (e.g., downlink, uplink, or sidelink) on a serving cell in the DRX group, the UE may start or restart the inactivity timer (e.g., the inactivity timer may reset each time the UE receives such a PDCCH transmission). The UE may determine a starting subframe of the DRX cycle based on a configuration parameter (e.g., drx-LongCycleStartOffset).

The wireless communications system 100 may support a UE 115 receiving periodic frames for extended reality (XR) applications. For such applications, XR traffic may be delay-sensitive (e.g., if a frame is not received by a frame reception deadline, the frame may no longer be useful to the application). Accordingly, the UE 115 may apply LP-WUS monitoring inside C-DRX active times to prioritize processing frames which arrive inside the active times (e.g., within a frame reception deadline) and to allow other frames to be discarded. In XR, the UE 115 may receive periodic downlink data frames, but there may be jitter associated with the periodic transmissions. It may be undesirable for the UE 115 to switch on its MR too early, or when frames are not expected (e.g., because this wastes power). In some examples, the UE 115 may switch on its MR after a particular LP-WUS MO that precedes an XR frame. Accordingly, a network entity 105 may transmit, to the UE 115, an LP-WUS in the particular LP-WUS MO (e.g., to prepare the UE 115 to receive the XR frame). In some cases, a DRX cycle may be configured so that the DRX cycle is equal to a periodicity of the XR frames. Similarly, the on duration timer duration may be configured to be equal to a jitter window of the XR frames. Accordingly, techniques described herein may support LP-WUS monitoring to enable power savings (e.g., in an XR scenario). As described herein, the term “DRX” may refer to C-DRX (e.g., connected mode DRX rather than an idle or inactive mode DRX). Accordingly, a “DRX cycle” may refer to a C-DRX cycle.

The wireless communications system 100 may support LP-WUS monitoring within a DRX cycle active time in accordance with an LP-WUS monitoring configuration to trigger PDCCH monitoring. For example, a UE 115 may receive one or more indications of a DRX configuration. The DRX configuration may include an on duration of a DRX cycle and a set of one or more LP-WUS MOs associated with the DRX cycle. The UE 115 may monitor for LP-WUSs associated with the UE 115 in accordance with the set of one or more LP-WUS MOs associated with the DRX cycle. In some examples, the UE 115 may monitor for downlink control transmissions (e.g., PDCCH transmissions) associated with the UE 115 in the on duration of the DRX cycle. For example, the UE 115 may monitor for the downlink control transmissions based on whether an LP-WUS associated with the UE 115 was received by the UE 115 in accordance with the monitoring for LP-WUSs associated with the UE 115. For example, if the UE 115 receives an LP-WUS, the UE 115 may begin monitoring for the downlink control transmissions for a monitoring duration associated with the received LP-WUS.

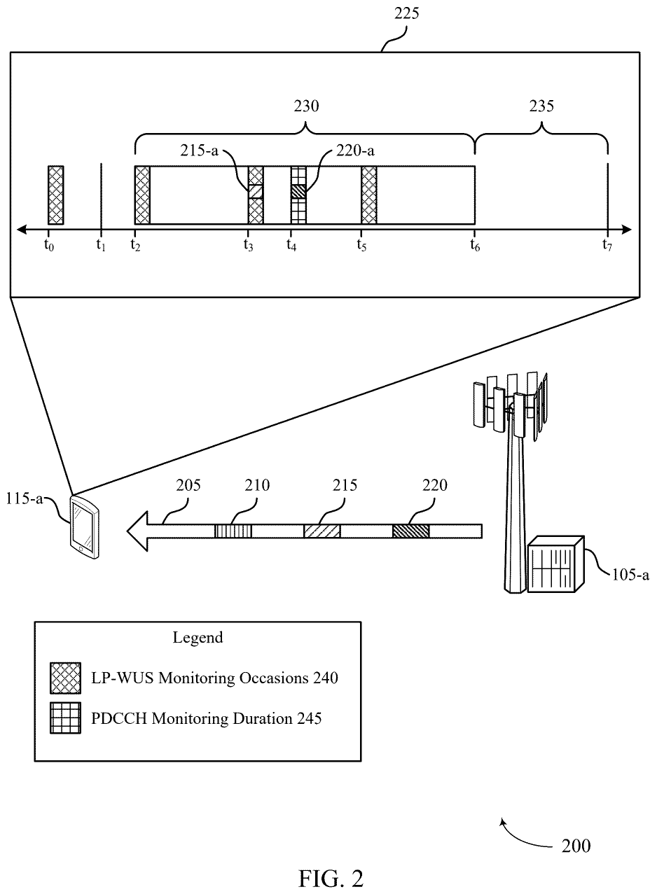

FIG. 2 shows an example of a wireless communications system 200 that supports DRX and LP-WUSs for wireless communication in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein. The UE 115-a may receive one or more signals via a wireless communication link 205 from the network entity 105-a.

The UE 115-a may receive configuration information 210 from the network entity 105-a via the wireless communication link 205. In some cases, the UE 115-a may include an MR and an LP-WUR for receiving signals. The UE 115-a may receive one or more LP-WUSs 215 via the LP-WUR and may receive one or more PDCCH transmissions 220 via the MR. The configuration information 210 may indicate a timing configuration 225 that the UE 115 follows for monitoring for LP-WUSs and for PDCCH transmissions. As illustrated, the timing configuration 225 may indicate a DRX cycle beginning at time t₁ and ending at t₇. The timing configuration 225 may indicate an on duration 230 of the DRX cycle, an off duration 235 of the DRX cycle, and LP-WUS MOs 240 associated with the DRX cycle. On durations 230 and off durations 235 may repeat in accordance with a periodicity of the DRX cycle (e.g., a DRX cycle duration).

The LP-WUS MOs 240 may be configured such that there may be at least one LP-WUS MO 240 prior to a start of the DRX cycle (e.g., before a start of an on duration timer associated with the DRX cycle), at least one LP-WUS MO 240 during the DRX cycle (e.g., while the on duration timer is, or would be, running), or both. The on duration timer may begin at a start of the on duration 230 (e.g., at time t₂). Thus, the on duration 230 may be a duration during which the on duration timer is running. In some examples, a duration between any pair of consecutive LP-WUS MOs 240 may be equal. In some cases, each LP-WUS MO 240 may be a single time occasion or a timing window. For example, if an LP-WUS is two symbols long, then a corresponding LP-WUS MO 240 may be two symbols long (one time occasion) or may be four symbols long (a timing window) (e.g., so that there may be three possible starts of LP-WUS).

In some implementations, time resources for the LP-WUS MOs 240 may be specified (e.g., in configuration information 210, in accordance with a communication standard) relative to the on duration 230 or relative to the start of the on duration times. Accordingly, if the on duration 230 is shifted in time, the LP-WUS MOs 240 may be shifted accordingly. In some examples, the network entity 105-a may change or reconfigure a DRX start offset (e.g., drx-LongCycleStartOffset) to shift a start of the on duration timer. The UE 115-a may receive an indication of such a change or reconfiguration (e.g., in configuration information 210) and may similarly shift the LP-WUS MOs 240 in time (e.g., by a same amount of time as the shift for the start of the on duration timer). In some cases, the LP-WUS MOs 240 within the on duration 230 may be configured (e.g., via an indication from the network entity 105-a) using offsets from the start of the on duration 230. For example, each LP-WUS MO 240 may start at a multiple of a time value (e.g., 1 ms) from the start of the on duration 230 (e.g., a respective LP-WUS MO 240 at 1 ms, at 2 ms, at 3 ms, and so on from the start of the on duration 230).

In some implementations, each LP-WUS MO 240 may be associated with a PDCCH monitoring duration 245 (e.g., a PDCCH monitoring window) within the on duration 230 of the DRX cycle. Each PDCCH monitoring duration 245 may begin at an offset after a corresponding LP-WUS MO 240. For example, the UE 115-a may receive (e.g., using a LP-WURR) an LP-WUS 215-a within an LP-WUS MO 240 at t₃. In response, the UE 115-a may trigger PDCCH monitoring (e.g., using an MR) within a PDCCH monitoring duration 245 corresponding to the LP-WUS MO 240 (e.g., the PDCCH monitoring duration 245 beginning at t₄). In another example, the UE 115-a may not receive an LP-WUS within a second LP-WUS MO 240 (e.g., at t₅). Accordingly, the UE 115-a may refrain from monitoring for PDCCH transmissions in a corresponding window (e.g., the UE 115-a may operate in a sleep mode instead of performing PDCCH monitoring during the corresponding window, may refrain from powering an MR). Additionally, or alternatively, the UE 115-a may monitor for LP-WUSs continuously during the on duration 230 (e.g., while the on duration timer is running).

As described herein, the UE 115-a may monitor for LP-WUSs in LP-WUS MOs 240 configured for the UE 115-a. The UE 115-a may be configured to operate a reception system (e.g., an MR, a LP-WUR, or combination thereof) using different sleep modes such as a deep sleep mode (which consumes a relatively low amount of power), a micro sleep mode, a light sleep mode (which consumes a higher amount of power than the deep sleep mode), and so on. While the on duration timer is running, the UE 115-a may put the reception system (e.g., MR) into a first sleep mode that is associated with a relatively fast wake up time (e.g., a light sleep mode with a fastest wake up time). As a result, the UE 115-a may switch the MR to a full capability (e.g., a wake-up mode) within a threshold duration. At an end of an active time (e.g., after the on duration timer or an inactivity timer has expired), the UE 115-a may switch the MR to a second sleep mode (e.g., a deep sleep mode). For example, the UE 115-a may enter the deep sleep mode in response to an expiration of one or more timers (e.g., the on duration timer, the inactivity timer, or both).

In some implementations, the UE 115-a may monitor for PDCCH transmissions (e.g., from the network entity 105-a) some duration after receiving an LP-WUS 215 (e.g., the LP-WUS 215-a). For example, there may be a delay between the LP-WUS MO 240 and the corresponding PDCCH monitoring duration 245. In some cases, if the UE 115-a receives a PDCCH transmission 220-a indicating a new transmission, the UE 115-a may start (or restart) the inactivity timer (e.g., drx-InactivityTimer). The UE 115-a may continue to monitor for PDCCH transmissions while the inactivity timer is running. In some examples, in response to an expiration of the inactivity timer, the UE 115-a may refrain from monitoring for PDCCH transmissions even if the on duration timer is running. Additionally, or alternatively, the UE 115-a may monitor for PDCCH transmissions until an end of the PDCCH monitoring duration 245 corresponding to the LP-WUS MO 240. In some implementations, the UE 115-a may refrain from monitoring for PDCCH transmissions if the on duration timer is not running, if the inactivity timer is not running, or both. If the inactivity timer is not running, or if the UE did not receive an LP-WUS 215 within an LP-WUS MO 240, the UE 115-a may refrain from monitoring for PDCCH transmissions in a corresponding PDCCH monitoring duration 245.

In some implementations, there may be a first LP-WUS MO 240 prior to a start of the on duration 230 (e.g., before a start of the on duration timer). If the UE 115-a receives an LP-WUS 215 during the first LP-WUS MO 240, the UE 115-a may monitor for PDCCH transmissions in response to a start of the on duration 230. That is, a PDCCH monitoring duration 245 corresponding to the first LP-WUS MO 240 may begin at the start of the on duration 230. In some cases, each PDCCH monitoring duration 245 may span between a pair of consecutive LP-WUS MOs 240. Additionally, or alternatively, a last PDCCH monitoring duration 245 may span between an LP-WUS MO 240 positioned last within the on duration 230 and an end of the on duration 230. At the end of the on duration 230 (e.g., at time t₆), the UE 115-a may enter a deep sleep mode for the off duration 235. At an end of the DRX cycle (e.g., at time t₇), the UE 115-a may repeat this process with a next DRX cycle (beginning at time t₇ or beginning after a delay beyond t₇).

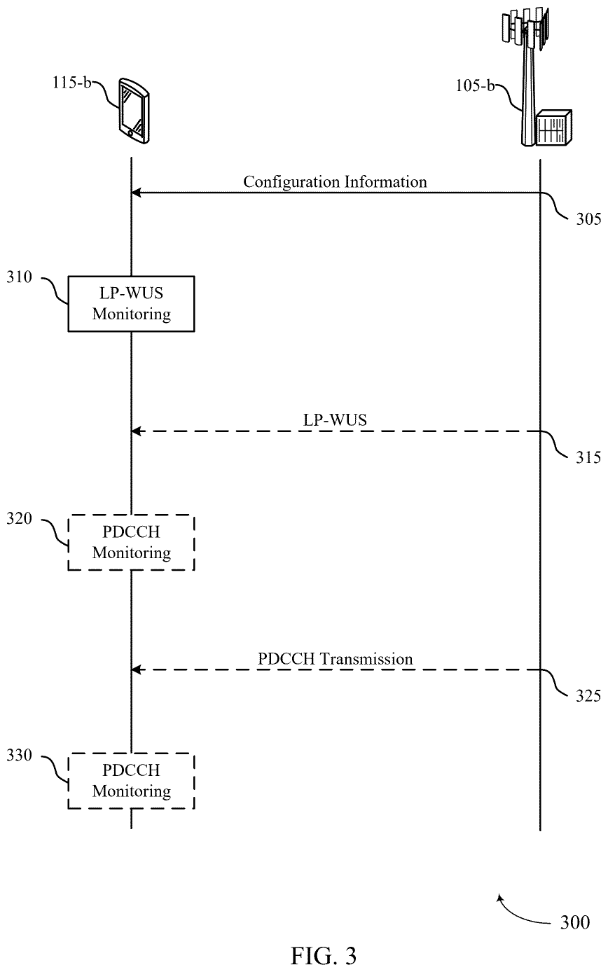

FIG. 3 shows an example of a process flow 300 that supports DRX and LP-WUSs for wireless communication in accordance with one or more aspects of the present disclosure. The process flow 300 includes a UE 115-b and a network entity 105-b, which may be examples of the corresponding devices as described with respect to FIGS. 1 and 2. In the following description of the process flow 300, the operations between the UE 115-b and the network entity 105-b may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

At 305, the UE 115-b may receive, from the network entity 105-b, configuration information indicating an on duration of a DRX cycle and a set of one or more LP-WUS MOs associated with the DRX cycle. In some cases, at least one of the set of one or more LP-WUS MOs may be configured to occur before the on duration of the DRX cycle. Additionally, or alternatively, at least one of the set of one or more LP-WUS MOs may be configured to occur in the on duration of the DRX cycle. Similarly, at least one of the set of one or more LP-WUS MOs may be configured to occur while a timer associated with the on duration of the DRX cycle is running. In some implementations, the configuration information may indicate a periodicity of the DRX cycle that corresponds to a video frame rate of an application (e.g., a frame rate of an XR application). In some examples, the set of one or more LP-WUS MOs may be associated with a set of occasions in accordance with a periodic interval. In some cases, respective durations between consecutive LP-WUS MOs of the set may be equal (e.g., LP-WUS MOs may be equally spaced in time).

At 310, the UE 115-b may monitor for LP-WUSs associated with the UE 115-b. The UE 115-b may monitor for the LP-WUSs in accordance with the set of one or more LP-WUS MOs associated with the DRX cycle (e.g., using an LP-WUR). In some cases, monitoring for LP-WUSs associated with the UE 115-b may correspond to a continuous monitoring in the on duration of the DRX cycle. That is, the UE 115-b may continuously monitor for LP-WUSs during the on duration of the DRX cycle. In some implementations, while monitoring for LP-WUSs associated with the UE 115-b, the UE 115-b may operate a reception system (e.g., including an MR, an LP-WUR, or a combination thereof) of the UE 115-b in accordance with a first power mode associated with a first wakeup duration and a first operating power. Similarly, in an off duration of the DRX cycle, the UE 115-b may operate the reception system in accordance with a second power mode associated with a second wakeup duration that is greater than the first wakeup duration. The UE 115-b may operate the reception system in accordance with a second operating power that is less than the first operating power.

At 315, in some cases, the UE 115-b may receive an LP-WUS from the network entity 105-b. In response to receiving the LP-WUS, the UE 115-b may operate the reception system in accordance with a third power mode corresponding to an awake state of the reception system (e.g., may power on aspects of an MR). The third power mode may be different than the first power mode and the second power mode.

At 320, the UE 115-b may monitor for PDCCH transmissions (e.g., or other downlink transmissions) associated with the UE 115-b in the on duration of the DRX cycle (e.g., using an MR). In some cases, the UE 115-b may monitor for the PDCCH transmissions based on operating the reception system in accordance with the third power mode (e.g., the awake state). The UE 115-b may determine whether to monitor for the PDCCH transmissions at 320 based on whether an LP-WUS associated with the UE 115-b was received by the UE 115-b in accordance with the monitoring for LP-WUSs associated with the UE 115-b. For example, the UE 115-b may refrain from monitoring for the PDCCH transmissions if the UE 115-b did not receive an LP-WUS (e.g., at 315). Additionally, or alternatively, the UE 115b may monitor for the PDCCH transmissions for a first duration in response to a reception of the LP-WUS (e.g., at 315).

At 325, the UE 115-b may receive, in the first duration, a PDCCH transmission based on monitoring for the PDCCH transmissions. In response, the UE 115-b may start an inactivity timer. In some examples, at 330, the UE 115-b may continue to monitor for the PDCCH transmissions based on a state of the inactivity timer (e.g., continuing to monitor while the inactivity timer is running). In such cases, the first duration may be based on the state of the inactivity timer. In some examples, the UE 115-b may continue to monitor for the PDCCH transmission until an expiration of the inactivity timer. Additionally, or alternatively, the UE 115-b may continue to monitor for the PDCCH transmissions until an end of a PDCCH monitoring window (e.g., duration) corresponding to the LP-WUS. The PDCCH monitoring window may start after the reception of the LP-WUS or after the LP-WUS MO (and in some examples after a delay). Further, the PDCCH monitoring window may span until a next LP-WUS MO or until an end of the on duration of the DRX cycle.

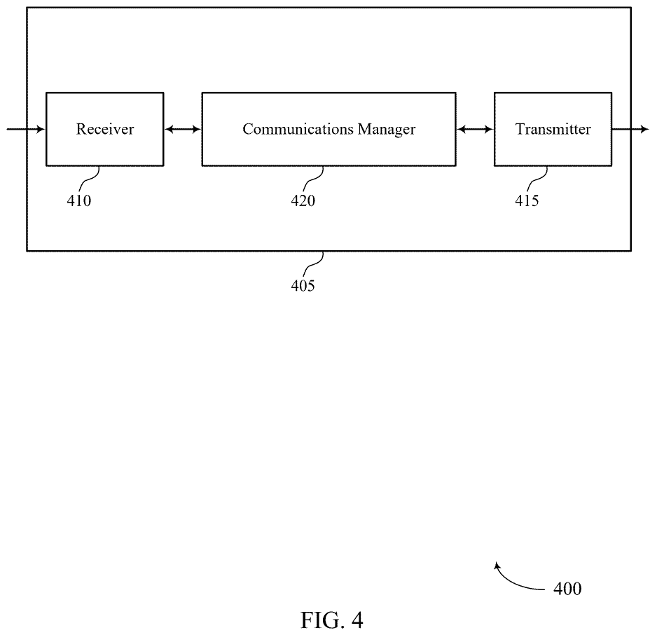

FIG. 4 shows a block diagram 400 of a device 405 that supports DRX and LP-WUSs for wireless communication in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to DRX and LP-WUSs for wireless communication). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to DRX and LP-WUSs for wireless communication). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of DRX and LP-WUSs for wireless communication as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving configuration information indicating an on duration of a DRX cycle and a set of one or more LP-WUS MOs associated with the DRX cycle. The communications manager 420 is capable of, configured to, or operable to support a means for monitoring, in accordance with the set of one or more LP-WUS MOs associated with the DRX cycle, for LP-WUSs associated with the UE. The communications manager 420 is capable of, configured to, or operable to support a means for monitoring, in the on duration of the DRX cycle, for PDCCH transmissions associated with the UE based on whether an LP-WUS associated with the UE was received by the UE in accordance with the monitoring for LP-WUSs associated with the UE.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for DRX and LP-WUSs for wireless communication, which may result in reduced processing, more efficient processing of XR frames, reduced power consumption, and more efficient utilization of communication resources, among other advantages.

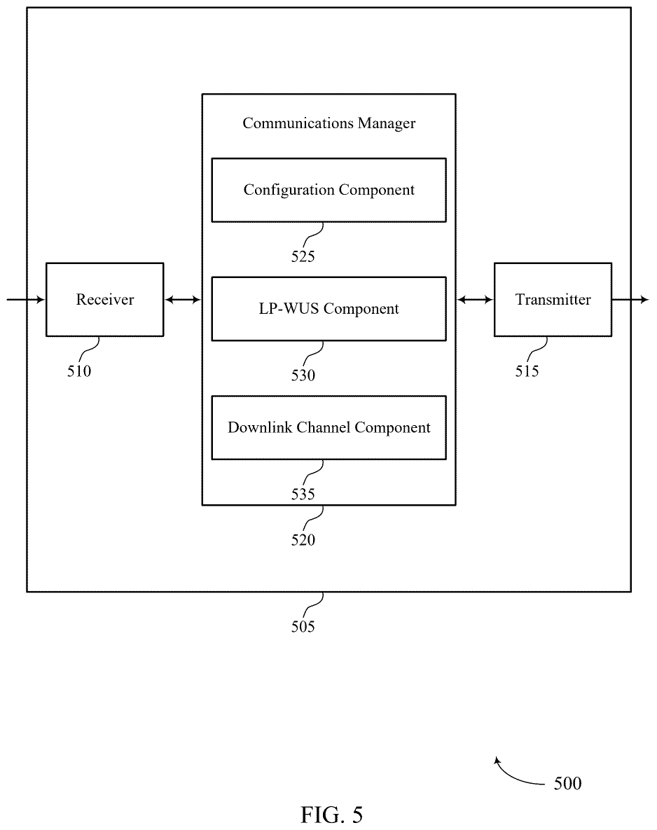

FIG. 5 shows a block diagram 500 of a device 505 that supports DRX and LP-WUSs for wireless communication in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to DRX and LP-WUSs for wireless communication). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to DRX and LP-WUSs for wireless communication). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of DRX and LP-WUSs for wireless communication as described herein. For example, the communications manager 520 may include a configuration component 525, an LP-WUS component 530, a downlink channel component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration component 525 is capable of, configured to, or operable to support a means for receiving configuration information indicating an on duration of a DRX cycle and a set of one or more LP-WUS MOs associated with the DRX cycle. The LP-WUS component 530 is capable of, configured to, or operable to support a means for monitoring, in accordance with the set of one or more LP-WUS MOs associated with the DRX cycle, for LP-WUSs associated with the UE. The downlink channel component 535 is capable of, configured to, or operable to support a means for monitoring, in the on duration of the DRX cycle, for PDCCH transmissions associated with the UE based on whether an LP-WUS associated with the UE was received by the UE in accordance with the monitoring for LP-WUSs associated with the UE.

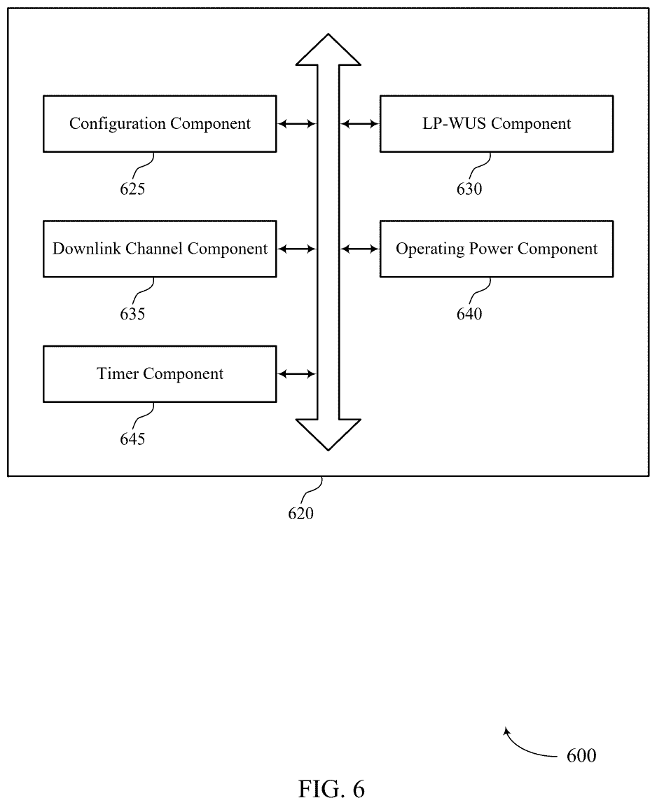

FIG. 6 shows a block diagram 600 of a communications manager 620 that supports DRX and LP-WUSs for wireless communication in accordance with one or more aspects of the present disclosure. The communications manager 620 may be an example of aspects of a communications manager 420, a communications manager 520, or both, as described herein. The communications manager 620, or various components thereof, may be an example of means for performing various aspects of DRX and LP-WUSs for wireless communication as described herein. For example, the communications manager 620 may include a configuration component 625, an LP-WUS component 630, a downlink channel component 635, an operating power component 640, a timer component 645, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration component 625 is capable of, configured to, or operable to support a means for receiving configuration information indicating an on duration of a DRX cycle and a set of one or more LP-WUS MOs associated with the DRX cycle. The LP-WUS component 630 is capable of, configured to, or operable to support a means for monitoring, in accordance with the set of one or more LP-WUS MOs associated with the DRX cycle, for LP-WUSs associated with the UE. The downlink channel component 635 is capable of, configured to, or operable to support a means for monitoring, in the on duration of the DRX cycle, for PDCCH transmissions associated with the UE based on whether an LP-WUS associated with the UE was received by the UE in accordance with the monitoring for LP-WUSs associated with the UE.

In some examples, to support monitoring for the PDCCH transmissions, the downlink channel component 635 is capable of, configured to, or operable to support a means for monitoring for the PDCCH transmissions for a first duration in response to a reception of the LP-WUS.

In some examples, the downlink channel component 635 is capable of, configured to, or operable to support a means for receiving, in the first duration, a PDCCH transmission based on monitoring for the PDCCH transmissions. In some examples, the timer component 645 is capable of, configured to, or operable to support a means for starting an inactivity timer in response to receiving the PDCCH transmission. In some examples, the downlink channel component 635 is capable of, configured to, or operable to support a means for continuing to monitor for the PDCCH transmissions based on a state of the inactivity timer, where the first duration is based on the state of the inactivity timer.

In some examples, to support continuing to monitor for the PDCCH transmissions, the downlink channel component 635 is capable of, configured to, or operable to support a means for continuing to monitor for the PDCCH transmissions until an expiration of the inactivity timer.

In some examples, to support continuing to monitor for the PDCCH transmissions, the downlink channel component 635 is capable of, configured to, or operable to support a means for continuing to monitor for the PDCCH transmissions until an end of a PDCCH monitoring window corresponding to the LP-WUS.

In some examples, the downlink channel component 635 is capable of, configured to, or operable to support a means for refraining from monitoring for the PDCCH transmissions based on not receiving the LP-WUS.

In some examples, at least one of the set of one or more LP-WUS MOs is configured to occur before the on duration of the DRX cycle.

In some examples, at least one of the set of one or more LP-WUS MOs is configured to occur in the on duration of the DRX cycle.

In some examples, at least one of the set of one or more LP-WUS MOs is configured to occur while a timer associated with the on duration of the DRX cycle is running.

In some examples, the monitoring for LP-WUSs associated with the UE corresponds to a continuous monitoring in the on duration of the DRX cycle.

In some examples, the operating power component 640 is capable of, configured to, or operable to support a means for operating, while monitoring for LP-WUSs associated with the UE, a reception system of the UE in accordance with a first power mode associated with a first wakeup duration and a first operating power. In some examples, the operating power component 640 is capable of, configured to, or operable to support a means for operating, in an off duration of the DRX cycle, the reception system in accordance with a second power mode associated with a second wakeup duration that is greater than the first wakeup duration and a second operating power that is less than the first operating power.

In some examples, the LP-WUS component 630 is capable of, configured to, or operable to support a means for receiving the LP-WUS associated with the UE in accordance with the monitoring for LP-WUSs associated with the UE. In some examples, the operating power component 640 is capable of, configured to, or operable to support a means for operating, in response to receiving the LP-WUS, the reception system in accordance with a third power mode corresponding to an awake state of the reception system, different than the first power mode and the second power mode, where monitoring for the PDCCH transmissions is based on operating the reception system in accordance with the third power mode.

In some examples, the configuration information indicates that a periodicity of the DRX cycle corresponds to a video frame rate of an application.

In some examples, the set of one or more LP-WUS MOs is associated with a set of multiple occasions in accordance with a periodic interval.

In some examples, respective durations between consecutive LP-WUS MOs of the set are equal.

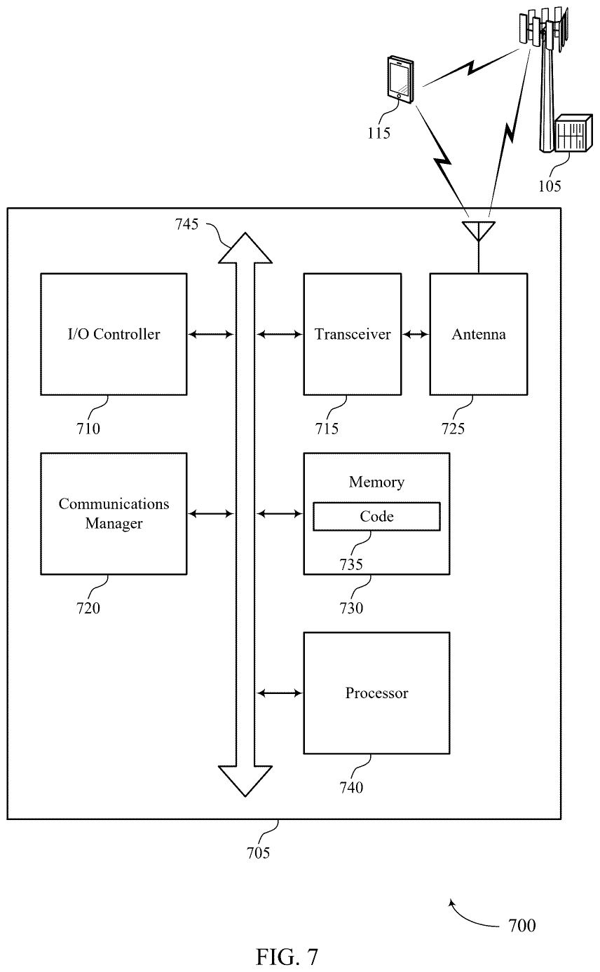

FIG. 7 shows a diagram of a system 700 including a device 705 that supports DRX and LP-WUSs for wireless communication in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting DRX and LP-WUSs for wireless communication). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving configuration information indicating an on duration of a DRX cycle and a set of one or more LP-WUS MOs associated with the DRX cycle. The communications manager 720 is capable of, configured to, or operable to support a means for monitoring, in accordance with the set of one or more LP-WUS MOs associated with the DRX cycle, for LP-WUSs associated with the UE. The communications manager 720 is capable of, configured to, or operable to support a means for monitoring, in the on duration of the DRX cycle, for PDCCH transmissions associated with the UE based on whether an LP-WUS associated with the UE was received by the UE in accordance with the monitoring for LP-WUSs associated with the UE.

By including or configuring the communications manager 720 in accordance with examples as described herein, the device 705 may support techniques for DRX and LP-WUSs for wireless communication, which may result in improved communication reliability, reduced latency, improved user experience related to reduced processing, more efficient processing of XR frames, reduced power consumption, improved coordination between devices, longer battery life, improved utilization of processing capability and more efficient utilization of communication resources, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of DRX and LP-WUSs for wireless communication as described herein, or the at least one processor 740 and the at least one memory 730 may be otherwise configured to, individually or collectively, perform or support such operations.

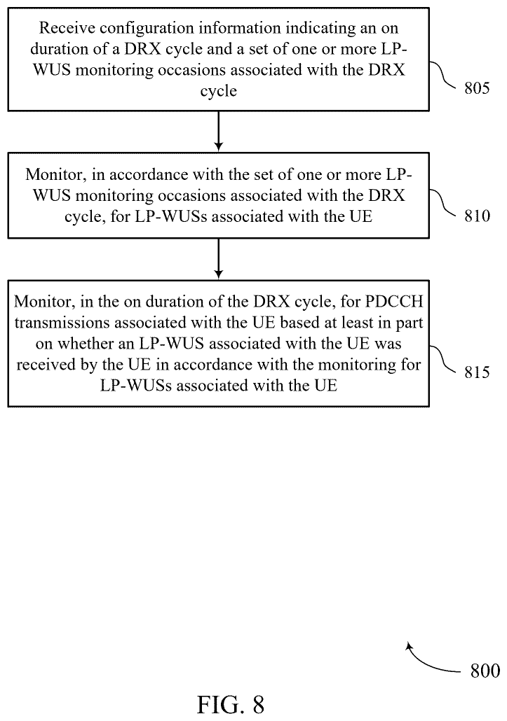

FIG. 8 shows a flowchart illustrating a method 800 that supports DRX and LP-WUSs for wireless communication in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving configuration information indicating an on duration of a DRX cycle and a set of one or more LP-WUS MOs associated with the DRX cycle. The operations of 805 may be performed in accordance with examples as disclosed herein. In some examples, aspects of the operations of 805 may be performed by a configuration component 625 as described with reference to FIG. 6.

At 810, the method may include monitoring, in accordance with the set of one or more LP-WUS MOs associated with the DRX cycle, for LP-WUSs associated with the UE. The operations of 810 may be performed in accordance with examples as disclosed herein. In some examples, aspects of the operations of 810 may be performed by an LP-WUS component 630 as described with reference to FIG. 6.

At 815, the method may include monitoring, in the on duration of the DRX cycle, for PDCCH transmissions associated with the UE based at least in part on whether an LP-WUS associated with the UE was received by the UE in accordance with the monitoring for LP-WUSs associated with the UE. The operations of 815 may be performed in accordance with examples as disclosed herein. In some examples, aspects of the operations of 815 may be performed by a downlink channel component 635 as described with reference to FIG. 6.

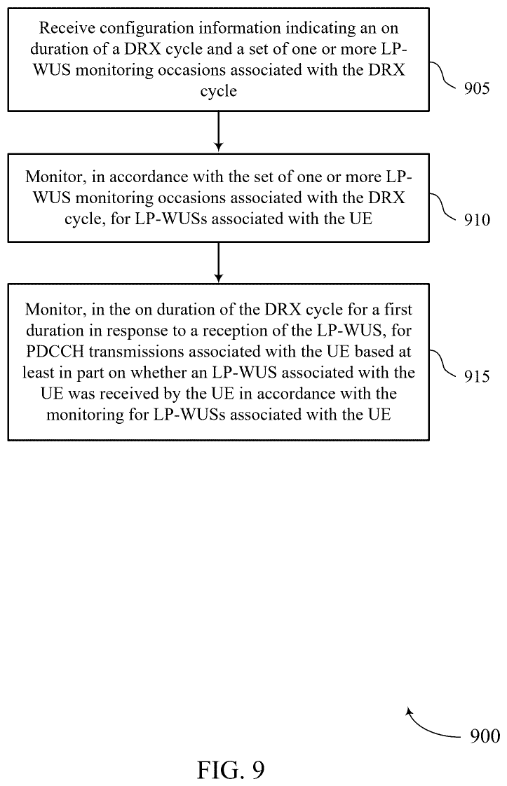

FIG. 9 shows a flowchart illustrating a method 900 that supports DRX and LP-WUSs for wireless communication in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving configuration information indicating an on duration of a DRX cycle and a set of one or more LP-WUS MOs associated with the DRX cycle. The operations of 905 may be performed in accordance with examples as disclosed herein. In some examples, aspects of the operations of 905 may be performed by a configuration component 625 as described with reference to FIG. 6.

At 910, the method may include monitoring, in accordance with the set of one or more LP-WUS MOs associated with the DRX cycle, for LP-WUSs associated with the UE. The operations of 910 may be performed in accordance with examples as disclosed herein. In some examples, aspects of the operations of 910 may be performed by an LP-WUS component 630 as described with reference to FIG. 6.

At 915, the method may include monitoring, in the on duration of the DRX cycle for a first duration in response to a reception of the LP-WUS, for PDCCH transmissions associated with the UE based at least in part on whether an LP-WUS associated with the UE was received by the UE in accordance with the monitoring for LP-WUSs associated with the UE. The operations of 915 may be performed in accordance with examples as disclosed herein. In some examples, aspects of the operations of 915 may be performed by a downlink channel component 635 as described with reference to FIG. 6.

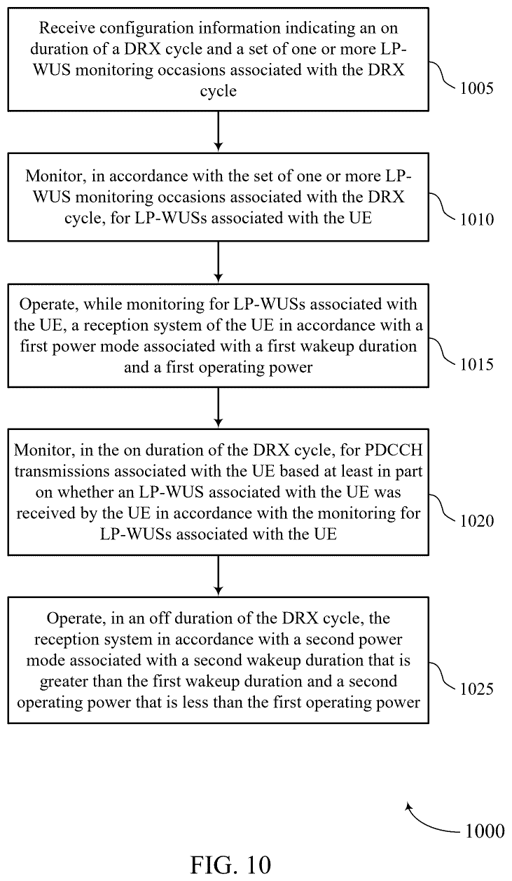

FIG. 10 shows a flowchart illustrating a method 1000 that supports DRX and LP-WUSs for wireless communication in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving configuration information indicating an on duration of a DRX cycle and a set of one or more LP-WUS MOs associated with the DRX cycle. The operations of 1005 may be performed in accordance with examples as disclosed herein. In some examples, aspects of the operations of 1005 may be performed by a configuration component 625 as described with reference to FIG. 6.

At 1010, the method may include monitoring, in accordance with the set of one or more LP-WUS MOs associated with the DRX cycle, for LP-WUSs associated with the UE. The operations of 1010 may be performed in accordance with examples as disclosed herein. In some examples, aspects of the operations of 1010 may be performed by an LP-WUS component 630 as described with reference to FIG. 6.

At 1015, the method may include operating, while monitoring for LP-WUSs associated with the UE, a reception system of the UE in accordance with a first power mode associated with a first wakeup duration and a first operating power. The operations of 1015 may be performed in accordance with examples as disclosed herein. In some examples, aspects of the operations of 1015 may be performed by an operating power component 640 as described with reference to FIG. 6.

At 1020, the method may include monitoring, in the on duration of the DRX cycle, for PDCCH transmissions associated with the UE based at least in part on whether an LP-WUS associated with the UE was received by the UE in accordance with the monitoring for LP-WUSs associated with the UE. The operations of 1020 may be performed in accordance with examples as disclosed herein. In some examples, aspects of the operations of 1020 may be performed by a downlink channel component 635 as described with reference to FIG. 6.

At 1025, the method may include operating, in an off duration of the DRX cycle, the reception system in accordance with a second power mode associated with a second wakeup duration that is greater than the first wakeup duration and a second operating power that is less than the first operating power. The operations of 1025 may be performed in accordance with examples as disclosed herein. In some examples, aspects of the operations of 1025 may be performed by an operating power component 640 as described with reference to FIG. 6.

The following provides an overview of aspects of the present disclosure:

Aspect 1: A method for wireless communications at a UE, comprising: receiving configuration information indicating an on duration of a DRX cycle and a set of one or more LP-WUS monitoring occasions associated with the DRX cycle; monitoring, in accordance with the set of one or more LP-WUS monitoring occasions associated with the DRX cycle, for LP-WUSs associated with the UE; and monitoring, in the on duration of the DRX cycle, for PDCCH transmissions associated with the UE based at least in part on whether a LP-WUS associated with the UE was received by the UE in accordance with the monitoring for LP-WUSs associated with the UE.

Aspect 2: The method of aspect 1, wherein monitoring for the PDCCH transmissions comprises: monitoring for the PDCCH transmissions for a first duration in response to a reception of the LP-WUS.

Aspect 3: The method of aspect 2, further comprising: receiving, in the first duration, a PDCCH transmission based at least in part on monitoring for the PDCCH transmissions; starting an inactivity timer in response to receiving the PDCCH transmission; and continuing to monitor for the PDCCH transmissions based at least in part on a state of the inactivity timer, wherein the first duration is based at least in part on the state of the inactivity timer.

Aspect 4: The method of aspect 3, wherein continuing to monitor for the PDCCH transmissions comprises: continuing to monitor for the PDCCH transmissions until an expiration of the inactivity timer.

Aspect 5: The method of any of aspects 3 through 4, wherein continuing to monitor for the PDCCH transmissions comprises: continuing to monitor for the PDCCH transmissions until an end of a PDCCH monitoring window corresponding to the LP-WUS.

Aspect 6: The method of any of aspects 1 through 5, further comprising: refraining from monitoring for the PDCCH transmissions based at least in part on not receiving the LP-WUS.

Aspect 7: The method of any of aspects 1 through 6, wherein at least one of the set of one or more LP-WUS monitoring occasions is configured to occur before the on duration of the DRX cycle.

Aspect 8: The method of any of aspects 1 through 7, wherein at least one of the set of one or more LP-WUS monitoring occasions is configured to occur in the on duration of the DRX cycle.

Aspect 9: The method of any of aspects 1 through 8, wherein at least one of the set of one or more LP-WUS monitoring occasions is configured to occur while a timer associated with the on duration of the DRX cycle is running.

Aspect 10: The method of any of aspects 1 through 9, wherein the monitoring for LP-WUSs associated with the UE corresponds to a continuous monitoring in the on duration of the DRX cycle.

Aspect 11: The method of any of aspects 1 through 10, further comprising: operating, while monitoring for LP-WUSs associated with the UE, a reception system of the UE in accordance with a first power mode associated with a first wakeup duration and a first operating power; and operating, in an off duration of the DRX cycle, the reception system in accordance with a second power mode associated with a second wakeup duration that is greater than the first wakeup duration and a second operating power that is less than the first operating power.

Aspect 12: The method of aspect 11, further comprising: receiving the LP-WUS associated with the UE in accordance with the monitoring for LP-WUSs associated with the UE; and operating, in response to receiving the LP-WUS, the reception system in accordance with a third power mode corresponding to an awake state of the reception system, different than the first power mode and the second power mode, wherein monitoring for the PDCCH transmissions is based at least in part on operating the reception system in accordance with the third power mode.

Aspect 13: The method of any of aspects 1 through 12, wherein the configuration information indicates that a periodicity of the DRX cycle corresponds to a video frame rate of an application.

Aspect 14: The method of any of aspects 1 through 13, wherein the set of one or more LP-WUS monitoring occasions is associated with a plurality of occasions in accordance with a periodic interval.

Aspect 15: The method of any of aspects 1 through 14, wherein respective durations between consecutive LP-WUS monitoring occasions of the set are equal.

Aspect 16: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 15.

Aspect 17: A UE for wireless communications, comprising at least one means for performing a method of any of aspects 1 through 15.

Aspect 18: A non-transitory computer-readable medium storing code for wireless communications, the code comprising instructions executable by one or more processors (e.g., directly, indirectly, after pre-processing, without pre-processing) to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), and ascertaining. Also, “determining” or “identifying” can include receiving (such as receiving information or signaling, e.g., receiving information or signaling for determining, receiving information or signaling for identifying), and accessing (such as accessing data in a memory, or accessing information). Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information indicating an on duration of a discontinuous reception (DRX) cycle and a set of one or more low-power wake-up signal monitoring occasions associated with the DRX cycle;
monitor, in accordance with the set of one or more low-power wake-up signal monitoring occasions associated with the DRX cycle, for low-power wake-up signals associated with the UE; and
monitor, in the on duration of the DRX cycle, for physical downlink control channel (PDCCH) transmissions associated with the UE based at least in part on whether a low-power wake-up signal associated with the UE was received by the UE in accordance with the monitoring for low-power wake-up signals associated with the UE.

2. The UE of claim 1, wherein, to monitor for the PDCCH transmissions, the one or more processors are individually or collectively operable to execute the code to cause the UE to:
monitor for the PDCCH transmissions for a first duration in response to a reception of the low-power wake-up signal.

3. The UE of claim 2, wherein the one or more processors are individually or collectively further operable to execute the code to cause the UE to:
receive, in the first duration, a PDCCH transmission based at least in part on monitoring for the PDCCH transmissions;
start an inactivity timer in response to receiving the PDCCH transmission; and
continue to monitor for the PDCCH transmissions based at least in part on a state of the inactivity timer, wherein the first duration is based at least in part on the state of the inactivity timer.

4. The UE of claim 3, wherein, to continue to monitor for the PDCCH transmissions, the one or more processors are individually or collectively operable to execute the code to cause the UE to:
continue to monitor for the PDCCH transmissions until an expiration of the inactivity timer.

5. The UE of claim 3, wherein, to continue to monitor for the PDCCH transmissions, the one or more processors are individually or collectively operable to execute the code to cause the UE to:
continue to monitor for the PDCCH transmissions until an end of a PDCCH monitoring window corresponding to the low-power wake-up signal.

6. The UE of claim 1, wherein the one or more processors are individually or collectively further operable to execute the code to cause the UE to:
refrain from monitoring for the PDCCH transmissions based at least in part on not receiving the low-power wake-up signal.

7. The UE of claim 1, wherein at least one of the set of one or more low-power wake-up signal monitoring occasions is configured to occur before the on duration of the DRX cycle.

8. The UE of claim 1, wherein at least one of the set of one or more low-power wake-up signal monitoring occasions is configured to occur in the on duration of the DRX cycle.

9. The UE of claim 1, wherein at least one of the set of one or more low-power wake-up signal monitoring occasions is configured to occur while a timer associated with the on duration of the DRX cycle is running.

10. The UE of claim 1, wherein the monitoring for low-power wake-up signals associated with the UE corresponds to a continuous monitoring in the on duration of the DRX cycle.

11. The UE of claim 1, wherein the one or more processors are individually or collectively further operable to execute the code to cause the UE to:
operate, while monitoring for low-power wake-up signals associated with the UE, a reception system of the UE in accordance with a first power mode associated with a first wakeup duration and a first operating power; and
operate, in an off duration of the DRX cycle, the reception system in accordance with a second power mode associated with a second wakeup duration that is greater than the first wakeup duration and a second operating power that is less than the first operating power.

12. The UE of claim 11, wherein the one or more processors are individually or collectively further operable to execute the code to cause the UE to:
receive the low-power wake-up signal associated with the UE in accordance with the monitoring for low-power wake-up signals associated with the UE; and
operate, in response to receiving the low-power wake-up signal, the reception system in accordance with a third power mode corresponding to an awake state of the reception system, different than the first power mode and the second power mode, wherein monitoring for the PDCCH transmissions is based at least in part on operating the reception system in accordance with the third power mode.

13. The UE of claim 1, wherein the configuration information indicates that a periodicity of the DRX cycle corresponds to a video frame rate of an application.

14. The UE of claim 1, wherein the set of one or more low-power wake-up signal monitoring occasions is associated with a plurality of occasions in accordance with a periodic interval.

15. The UE of claim 1, wherein respective durations between consecutive low-power wake-up signal monitoring occasions of the set are equal.

16. A method for wireless communications at a user equipment (UE), comprising:
receiving configuration information indicating an on duration of a discontinuous reception (DRX) cycle and a set of one or more low-power wake-up signal monitoring occasions associated with the DRX cycle;
monitoring, in accordance with the set of one or more low-power wake-up signal monitoring occasions associated with the DRX cycle, for low-power wake-up signals associated with the UE; and
monitoring, in the on duration of the DRX cycle, for physical downlink control channel (PDCCH) transmissions associated with the UE based at least in part on whether a low-power wake-up signal associated with the UE was received by the UE in accordance with the monitoring for low-power wake-up signals associated with the UE.

17. The method of claim 16, wherein monitoring for the PDCCH transmissions comprises:
monitoring for the PDCCH transmissions for a first duration in response to a reception of the low-power wake-up signal.

18. The method of claim 16, further comprising:
operating, while monitoring for low-power wake-up signals associated with the UE, a reception system of the UE in accordance with a first power mode associated with a first wakeup duration and a first operating power; and
operating, in an off duration of the DRX cycle, the reception system in accordance with a second power mode associated with a second wakeup duration that is greater than the first wakeup duration and a second operating power that is less than the first operating power.

19. A non-transitory computer-readable medium storing code for wireless communications at a user equipment (UE), the code comprising instructions executable by at least one processor to:
receive configuration information indicating an on duration of a discontinuous reception (DRX) cycle and a set of one or more low-power wake-up signal monitoring occasions associated with the DRX cycle;
monitor, in accordance with the set of one or more low-power wake-up signal monitoring occasions associated with the DRX cycle, for low-power wake-up signals associated with the UE; and
monitor, in the on duration of the DRX cycle, for physical downlink control channel (PDCCH) transmissions associated with the UE based at least in part on whether a low-power wake-up signal associated with the UE was received by the UE in accordance with the monitoring for low-power wake-up signals associated with the UE.

20. The non-transitory computer-readable medium of claim 19, wherein the instructions to monitor for the PDCCH transmissions are executable by the at least one processor to:
monitor for the PDCCH transmissions for a first duration in response to a reception of the low-power wake-up signal.
